(19) United States
(12) Patent Application Publication
(10) Pub. No.: US 2017/0180768 A1
(43) Pub. Date: Jun. 22, 2017

(54) SYSTEM FOR MANAGING MEDIA CONTENT FOR THE MOVIE AND/OR ENTERTAINMENT INDUSTRY

(71) Applicant: WORLD CONTENT POLE SA, Lugano (CH)

(72) Inventors: Maurizio Zuccarini, Sala Capriasca (CH); Giovanni Contri, Milano (IT)

(21) Appl. No.: 15/310,239

(22) PCT Filed: May 15, 2014
(86) PCT No.: PCT/EP2014/059928

§ 371 Date: Nov. 10, 2016

(51) Int. Cl. H04N 21/2343; H04N 21/61

(52) U.S. Cl. CPC H04N 21/234309; H04N 21/6125

(57) ABSTRACT

It is disclosed a system for managing media content for the movie and/or entertainment industry. The system includes means for managing administrative data, including users of the system, means for managing media assets, including the media content, means for transcoding the media content and means for delivering the media content, integrated together in a web platform; the system further includes a workflow process programmed to implement a management, a transcoding and a delivery of the media content through actions executed by the users with means for managing, means for transcoding and means for delivering, and through said administrative data.

### FIELD OF APPLICATION

The present invention relates to a system for managing media content for the movie and/or entertainment industry. The invention further relates to a method managing the media content for the movie and/or entertainment industry.

### PRIOR ART

System for managing media content in the media and entertainment industry are known and involve several players that operate different roles in order to produce and distribute a media content or media asset, i.e. feature film, documentary, TV series, aiming to broadcast it through different platforms, for instance Cinema, TV, WebTv. A typical media content production cycle involves several activities.

In particular, at the beginning of the production process, a shooting is done on a set using digital cameras, these last being devices programmed to save in digital formats (versus previous tape format), as schematically represented in FIG. 1.

After production, the multimedia content acquired and stored in digital formats is processed in post-production steps, i.e. it is “edited”, assembled with other content, for instance with audio tracks. These processes result in several multimedia content, for example different trailers, or movies in different versions or languages.

The “editing” step may include other operations dependent from the media content recipient's intention; for instance a so called “promo” may require a selection and cut of specific parts or audio specifically recorder for the promotional destination.

At the end of the “editing” step each media content is recorded on analog tapes (FIG. 1, “Stored on tapes”) and then duplicated in order (FIG. 1, “Cloned to tapes”) to be finally delivered using physical delivery services, for instance TNT or DHL services.

The media content delivered is usually not yet ready for the final user, i.e. for the broadcaster or the cinemas; indeed, it is previously delivered to an intermediate operator, generally a national distributor or a seller or a laboratory (Lab) to perform further activities, including language dubbing, scenes cutting, promo preparation, ect., and also for a transcoding to the format required by the final recipient.

Transcoding is a key process required to “convert” the original format of the media content into a format required by the broadcaster or cinema technical infrastructure. Only after transcoding, the media content is effectively delivered to the broadcaster, the WebTV or the cinema, again through a physical delivery service such as TNT or DHL.

Al the steps defined above is time and cost consuming, not only for the different persons involved, for the duplication or physical transport of the media content, but also for technical agreement, for instance transcoding format, to be agreed between the seller/distributor of the media content and the broadcaster but also with the intermediate laboratory involved in the real transcoding process.

Moreover, the physical distribution of the media content through the different operators increases the risk of theft and/or duplication of the media content, with relevant economic damage for the industry. On the other side, all the physical deliveries between operators, until final delivery, substantially increase the costs and the post-production time. The time and the final content quality are also affected by the need to convert from digital to analog format and vice-versa, as described above.

At last, the current system does not allow to monitor in real time the post-production activities, i.e. dubbing for language translation, trailer preparation, ect., and thus to properly plan or execute the license and distribution agreements.

The technical problem to be solved is that of providing a system that allows to manage the media content for reducing cost and time of post-production or transcoding or delivery, as well as the risk of piracy or duplication, increasing at the same time the content security during delivery and furthermore keeps the full process under tight control, thus overcoming the limits that currently affects the known systems.

### SUMMARY OF THE INVENTION

The idea at the base of the present invention is to provide a system for managing media content for the movie and/or entertainment industry, characterized by integrating:
means for managing administrative data, including users of the system;
means for managing media assets, including the media content;
means for transcoding the media content and
means for delivering the media content,
   wherein the system assembles said means for managing administrative data, said means for managing media assets, said means for transcoding the media content and said means for delivering the media content integrated in a web platform, and wherein
   the system includes a workflow process programmed to integrate and implement a management, a transcoding and a delivery of said media content through actions executed by said users through said means for managing, means for transcoding and means for delivering, and through said administrative data.

In an aspect of the invention, the means for managing administrative data comprises: —means to record companies in the system, at least one company being recorded with one or more corresponding transcoding profiles; —means to record users and access data in the system, each user being recorded with a corresponding user profile and being associated to one of said company and control an access of users to the system on the base of said user profile, said means to control enabling in the system means to load and/or edit and/or play and/or download the media content, if said access is given.

At least a user of the company has a user profile with access rights to terms, conditions and pricing stored in the system by another user of another company providing a service on a media asset, and wherein said workflow process drives the flow of said terms, conditions and pricing between said user and said another user until acceptance terms, conditions and pricing.

At least a user of the company has a user profile with access rights to require or define a transcoding profile to send or receive multimedia content, said transcoding profile being stored in the system and including a specification document to be processed by said integrated means to transcode, said transcoding profile including at least one of the following information or parameters for transcoding: codec, output frame rate, scan type, aspect ratio.

At least a user of the company has a user profile with access right to define, describe and classify media content or collaterals, said classification including, for the media content, at least feature film, documentary, TVSeries, MiniSeries, TVMovie, and for collaterals, at least video, audio, image, text, dubbing, archive, folder, production folder, DCP.

The content information are structured in a hierarchical form, including at least the following levels: original content, version, series, episode, details. At least at levels original content, version, series, episode, general information about the content are stored, including actors, genre, production year, original language, and at detail level technical information are stored, including at least one of the following: the file associated to the content, its filename, filesize, aspect ratio, frame rate, image size, file time codes and the description of the audio tracks comprising number, description, type, channel, language for a single or more audio streams, information on property rights of a licensor, including at least one of rights timeframe, license type, territory.

The collaterals are stored on a single level and each collateral may be linked to any level of said hierarchical structure of the content.

Means to upload and store in the system the media content and collaterals through a deposit order are also provided; the deposit order includes creation, approval, uploading, completion and closing steps, and the workflow process handles the above steps.

The means for transcoding the media content includes a transcoding software adapted to receiving in input the information of the specification document and a media content and to provide in output a media content transcoded according to the information (parameters for transcoding) of the specification document.

According to the invention, a test clip of small size (in byte) is provided to a user of a company that requests transcoding according to a specification document, wherein the workflow process is adapted to drive the request of transcoding of the test clip from the user of the company to a backend of the system, to drive the generation of the test clip in the backend, and to alert said user of the company when the test clip is ready to be tested.

According to the invention, the media content includes a media content of a greater size respect to the clip test, to be provided to the user of the company that requested transcoding according to the specification document, wherein the media content of a greater size is generated by the system only if the test clip has been approved by the user, wherein the approval of test clip by the user and the generation of the media content of greater size in the back end is driven by the workflow process.

An application is also include in the system to give access to media content and preview on tablets, including iPad.

The workflow process includes delivery order information to drive said means for delivering media content, wherein the delivery order information including information on rights and/or license on the media content and a grant period in which access to the media content in the system is given.

The above mentioned problem is also solved, according to the invention, by a method implemented by the system, and more particularly by a method to manage media content for the movie and/or entertainment industry, characterized by comprising the steps of
managing administrative data, including users of the system;
managing media assets, including the media content;
transcoding the media content and
delivering the media content,
   wherein the above steps are integrally executed in a web platform over the Internet and are coordinated with a workflow process through actions executed by the users.

Hereafter, further features of the system and the method of the invention are summarized.

The system comprises a multi-user Internet portal able to support the activities of management or the processing of a multimedia content for different users, protecting the content through a remote storage system and authorizing a user to perform operations on the multimedia content according to a profile of the user, such as allowing a producer to upload his/her movie on the remote storage system, allowing a translator user to access the movie to carry out the language translations or allowing an operator to transcode the movie into a plurality of formats for different broadcasters, as well as allowing the broadcaster to download the movie to its final execution.

In the following documentation, the term movie or multimedia content or media content are used as synonyms to identify a digital content which is initially recorded with a digital camera on a set an successively post-produced in digital format to be delivered electronically through the Internet portal or system to different users, for different scope and in different versions, for instance for previewing in the system or for downloading in a predetermined format allowing transmission in an external platform or for transmission as a trailer together with promotional content.

The system includes means for automatically transcoding said media content in a format or transcoding profile defined in the technical profiles by the companies' users who access the system to download the media content for transmission in said format in an external platform.

The companies' users include television broadcaster, cinema, IPTV, mobile TV, WebTV, MSOs. The users of the system further include producers, owners, buyers and sellers of the media content.

Advantageously, time for the media content management are reduced because not physical delivery is required, since the access to the media content is done directly in the system and controlled by the system. Moreover, no conversion from digital to analog format or vice versa are required because the media content is stored in digital format and directly edited in the system or delivered to through the system in such a format. There is no risk of duplication, since the access to unknown users is forbidden.

In an aspect of the invention, the means to control includes the workflow process programmed to give access to the broadcaster's users if the broadcaster's users have agreed in the system to a license or furniture of the media content. The workflow process is further programmed to give access to the broadcaster's users if the format that has been specified in the profile by the broadcaster's users and after that the means for transcoding have transcoded the media content in the format specified by the broadcaster.

Advantageously, the workflow process allows to further speed up the postproduction process and the delivery. For instance, as soon as the producer and the broadcaster have agreed on costs or technical information, such as the format, the media content may be automatically transcoded and immediately delivered to the broadcaster.

The format includes a file extension of the media content, comprising 3GP, AVI, Avid, DIF, DIVX, DV, F4V, FLV, M4V, MP4, Quicktime, WMX, 360System, Avid Media Stream, EVS, GXF, Harris, LXF, MP4XDCAM EX, MPEG1-SS, MPEG2-ES, MPEG2-PS, MPEG2-TS, Omneon and/or OP1a, SeaChange, SeaChange SAF, Sony MAV70SXF, VOB Non encrypted, MXFOP1A, MXF OPAtom/XML.

In this respect, the media content may be transcoded in a plurality of formats associated to different user profiles, without involving physical delivery to laboratories.

In another important aspect of the present invention, the user profile includes a language of the media content and the means for editing are programmed to apply to the media content an audio in the language of the user profile. The user profile may further include a parental guidance for the media content and the means for editing may be programmed to cut the media content, to comply with the parental guidance of the user profile.

Advantageously, the means for editing further speed up the process, since the media content is directly modified within the system. Moreover, the system avoid errors in the language translations or format transcoding, since the language or transcoding format, as well as any parameters to be respected by the media content to be delivered, may be specified directly by the user owner of the profile.

According to another aspect of the invention, the user profile further includes a compressed format or a definition level of the media content.

The definition level includes a high or memory consuming definition, which is set for the media content to be downloaded and then transmitted in the external platform, or a lower and less consuming definition, which is set for the media content to the previewed in the system. The preview of the media content is preferably in streaming. The preview simplifies the presentation of the media content at festivals or during commercial meeting, since no physical media or duplication is required. Moreover, the system can give access to a plurality of media content.

The system includes a remote storage of the media content, preferably a cloud based storage, whereto the user connects via the Internet. Means for searching the media content, including metadata associated to the media content, are provided to help the user searching content.

Further characteristics and advantages of the system and method according to the present invention will become apparent from an embodiment thereof, given as an example only and not limitation with reference to the accompanying figures.

### BRIEF DESCRIPTION OF DRAWINGS

FIG. 1 is a schematic representation of a method for managing media content according to the prior art.

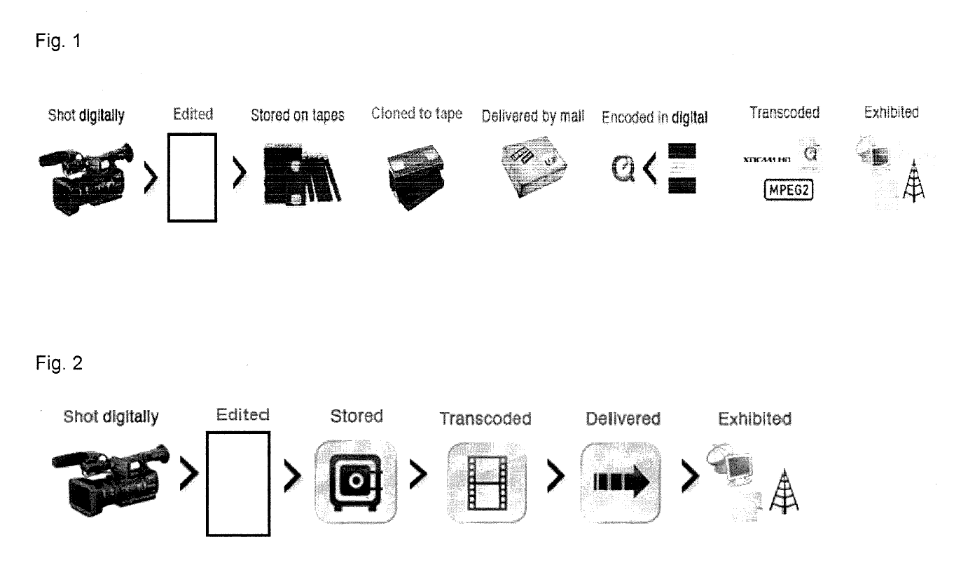

FIG. 2 is a schematic representation of a method for managing media content according to the present invention.

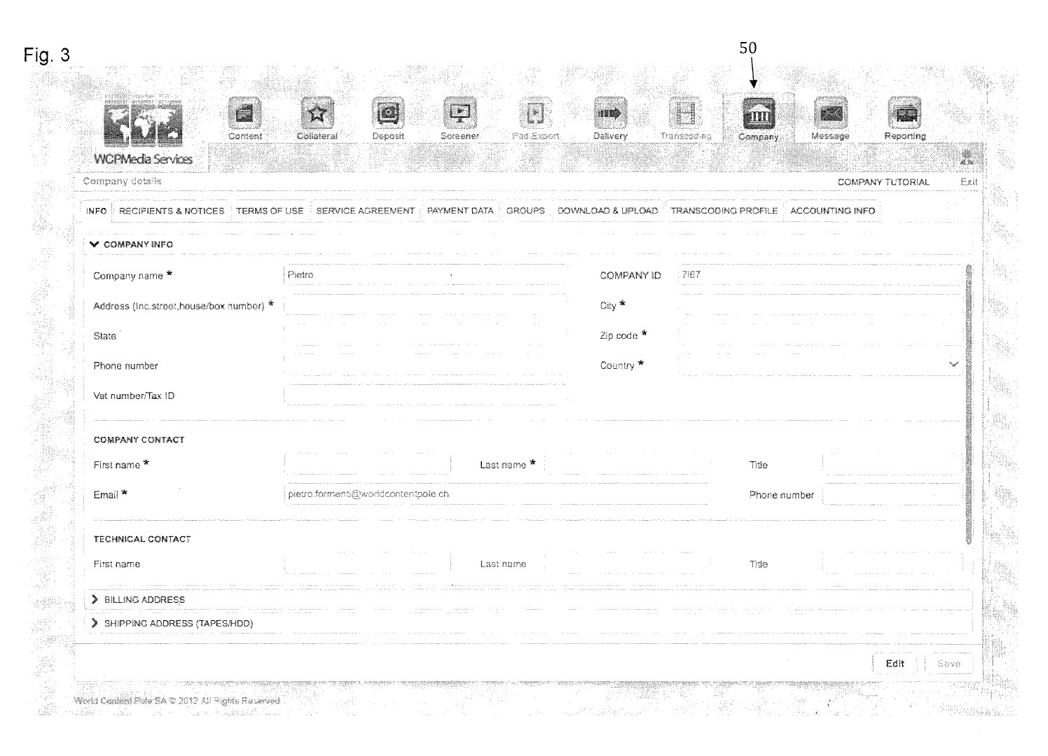

FIG. 3 is a user interface to input administrative data in the system according to the present invention.

FIG. 4 is a user interface on terms of use of the system according to the present invention.

FIG. 5 is a user interface on a content list of the system according to the present invention.

FIG. 6 is a user interface on content details of the system according to the present invention.

FIG. 7 is a user interface to preview in streaming according to the system of the present invention.

FIG. 8 is a user interface on a summary of a deposit order of the system according to the present invention.

FIG. 9 is a user interface on a transcoding profile of the system according to the present invention.

FIG. 10 is a user interface on a screener application of the system according to the present invention.

FIG. 11 is a user interface on a delivery order of the system according to the present invention.

FIG. 12 is a user interface on messages of the system according to the present invention.

### DETAILED DESCRIPTION OF THE INVENTION

The technical solution provided by the applicant is a Business-to-Business, multi-user, multi-company, web-application system or platform, able to support the cooperation of users along all the supply chain management of the production and postproduction processes of media content. The above system provides storing the media content in a safe and remote system or cloud, together with associated metadata, and enabling each user to define and execute activities on the base of his specific profile. The activities include loading and storing the media content in the system, sending the content for a work order to another user of the system, for example a language dubber, electronically delivering the media content in the system to another user, for example to a broadcaster according to specific license agreements stored in the system, allowing a user to access a screener for market development, etc. . . . .

More particularly, the system includes
means for managing administrative data, including users of the system;
means for managing media assets, including the media content;
means for transcoding the media content and
means for delivering the media content,
   wherein the system integrates the means for managing administrative data, the means for managing media assets, the means for transcoding the media content and the means for delivering the media content in a web platform, and wherein
   the system includes a workflow processor programmed to implement a management, a transcoding and a delivery of said media content through actions executed by the users through said means for managing, means for transcoding and means for delivering,
   and through the administrative data.

The workflow processor according to the present invention is a program or a plurality of programs or software integrated in the system and adapted to implement and drive flows of data and processes in the system and, more particularly, to implement and drive the processes of managing, transcoding and a delivering of media content.

Here after, the above means for managing administrative data, for managing media assets, for transcoding the media content and for delivering the media content, are described in detail, together with the workflow processor. More particularly, each of the above means provides a plurality of actions, to be performed manually by a user or automatically by the system, whose sequence of execution is integrally guided by the workflow processor within the system to manage the media asset, to transcode the corresponding media content or to delivery it.

In this respect, the means for managing administrative data support a manual insertion (creation) of a company or an automatic insertion. The manual insertion is executed manually in a backend of the system. The automatic insertion may be executed sending a content to a company not registered yet in the system; after sending, the company to which the content is addressed to, administrative data are automatically inserted in the system In both cases, the system assigns a first user group (“Admin”) to the company and inserts in such group a first user (“Administrator”) with all permissions for managing the corresponding company media assets in the system.

The system is programmed to automatically send an email to the first user with the credentials (username and password) to enter the system, preferably requesting a change of password at the first access for security. The first user (“Administrator”) can insert new users and user groups and specify for each user group one or more permissions. The system is programmed for controlling, through the permissions, which action any user in a user group is allowed to perform. Of course, a user may be associated to more than one group. The association of the user to groups and to corresponding permissions defines his/her user profile, i.e. the actions allowed to the user. The Administrator is allowed to disable a selected user, setting a disabling flag which deny access to such user.

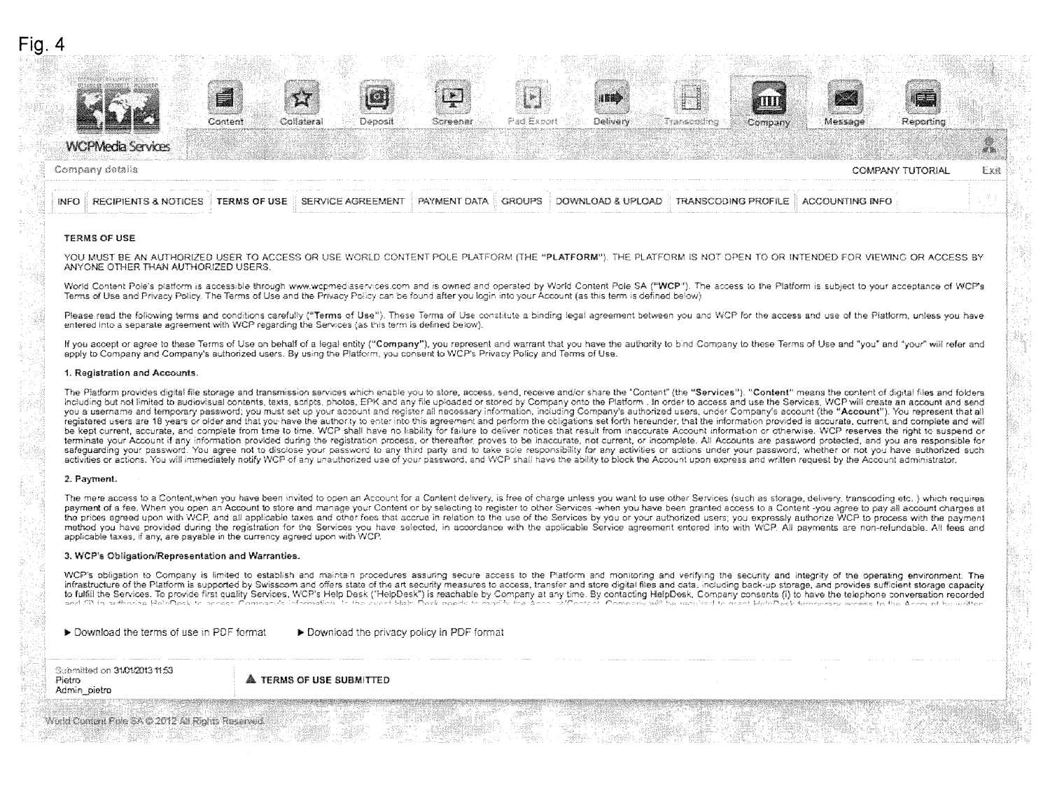

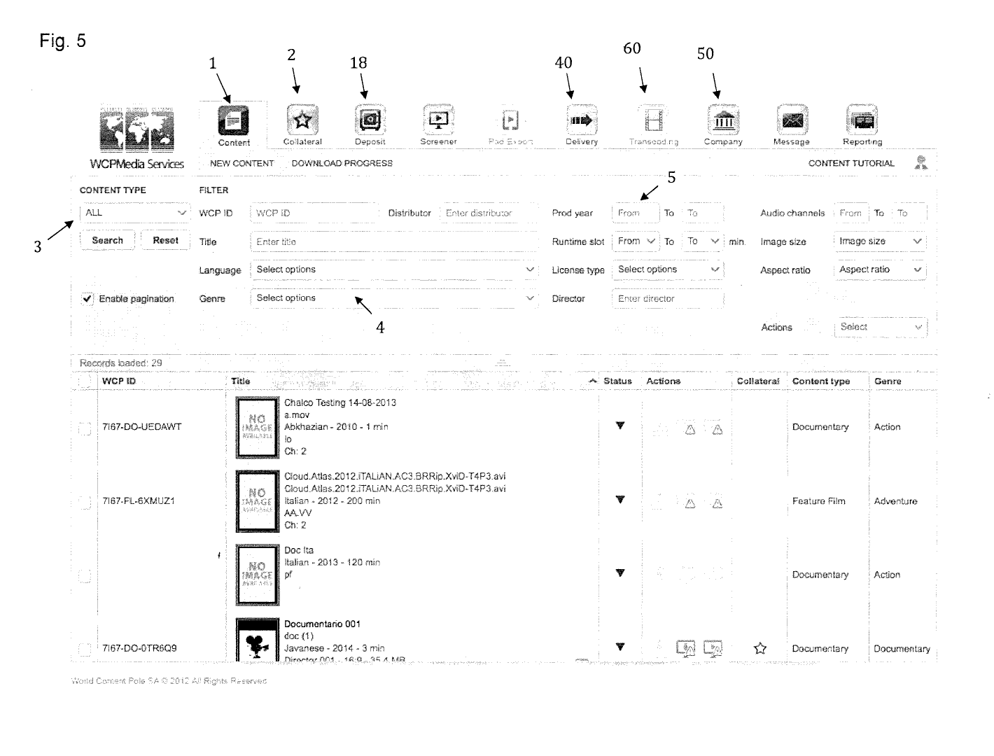

The users of a company may insert administrative information of the company, for instance invoicing data, shipping info (FIG. 3), and can also sign for acceptance terms and conditions (FIG. 4) and pricing for the services provided by the system. Within the system, there are also defined users entitled to receive emails from the system and/or to monitor specific actions, for instance the deposit of a multimedia content in the system or delivery workflows or install agents for automatic upload in the system a multimedia content, from a predetermined location of a local storage, or download from system a multimedia content, in a predetermined location of a local storage.

At last, in the system are also specified the users allowed to require a definition of a transcoding profile needed to send or receive multimedia content.

The means for managing media assets are described here below.

Core functions implemented by these means are definitions, description and classification of a media content or a collateral.

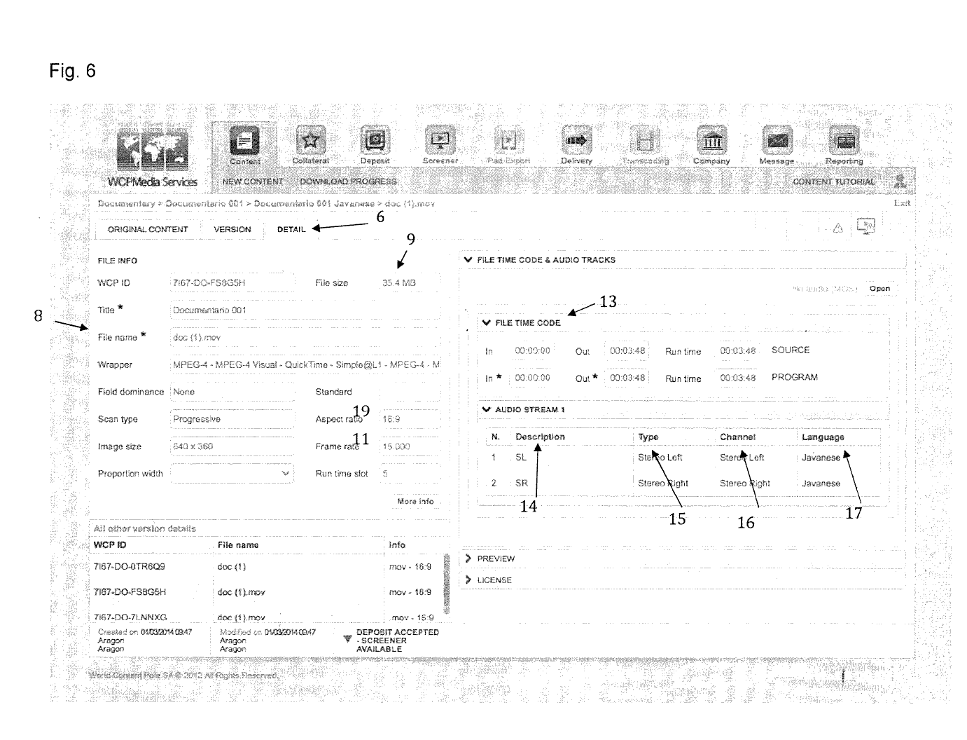

With reference to FIG. 5, any content or collateral may be classified among several types 3 (i.e. for content: feature film, documentary, TVSeries, MiniSeries, TVMovie; for collaterals: video, audio, image, text, dubbing, archive, folder, production folder, DCP). With numeral reference 1 an icon to access to the means for managing media asset, and more particularly to access media content according to the invention is indicated; a separate icon 2 is provided to access to collateral and for their management.

According to the type, the system allows to associate different attributes and information to the content or the collateral.

The content information is structured in a hierarchical form, according to the content type, the levels being: original content, version, series, episode, detail (FIG. 5). Information are managed at a different hierarchical level (i.e. a single episode is described as part of a season that is then characterized by a production period and generally a number of episodes; also episode's metadata like director, distributor, production year are at “episode” level instead of at “original content” level as it is for TV Movie or for documentary. The lasts vice versa do not require the Season).

This approach allows the system to handle many versions for the same original content (i.e. having different languages, parental guidance, the director cuts, etc.) so providing a structured and ordered way to manage complex content.

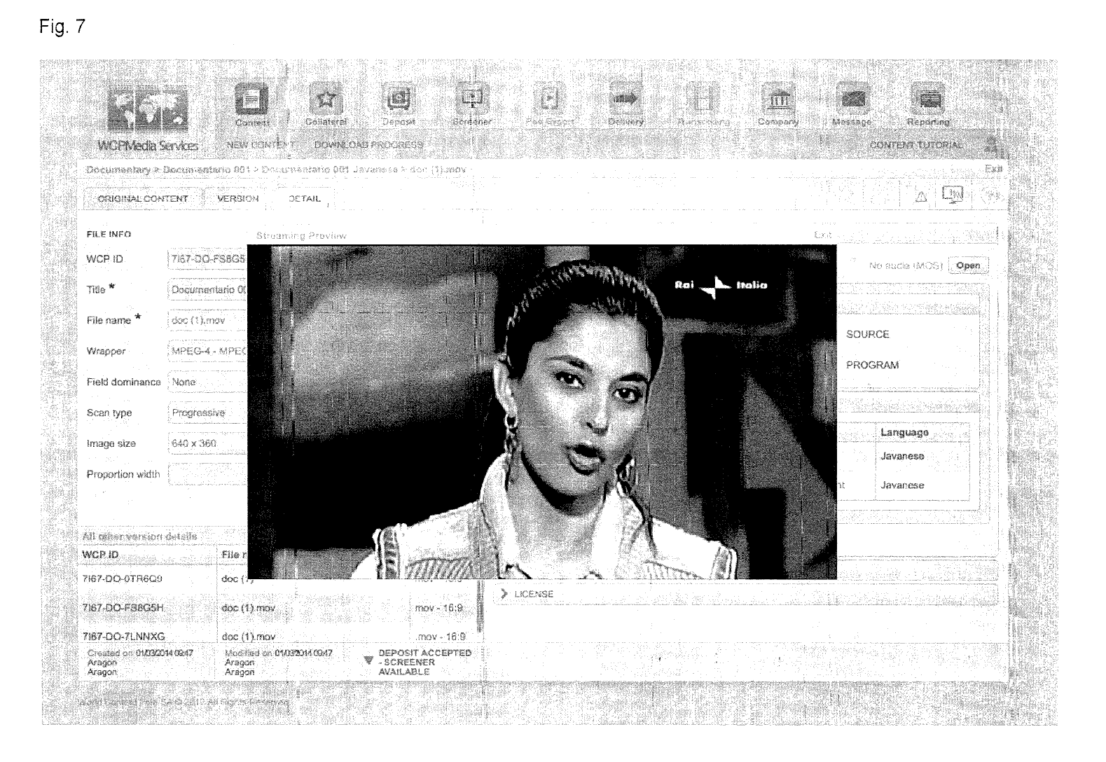

As represented in FIG. 6, while at “original content A/version B/series/episode” level the associated data regards general information about the content (i.e. actors, genre 4, production year 5, original language, etc.) at “detail” level 6 the system manages the technical information regarding the physical file that represent the content and that is loaded in the system (i.e. filename 8, filesize 9, aspect ratio 10, frame rate 11, image size 12, etc.) (FIG. 6).

Also at “detail” level the system keeps the information about the file time codes 13 and the description of the audio tracks (i.e. number, description 14, type 15, channel 16, language 17) for a single or more audio streams. Then information about the rights controlled by the licensor is here managed (i.e. rights timeframe, license type, territory, etc.).

In case a company requires to upload other metadata, eventually structured according to his needs, the system allows to use XML technology to upload all the additional info required.

Regarding the collaterals, the metadata structure is simpler and it's on a single level; metadata are different according to the type of collateral (i.e. it includes all the audio tracks description in case of a “dubbing”, an “audio” or a “video”, information that is not present for an “image”, this last having a specific playbill associated).

Each collateral can be linked to any hierarchical level of content. This allows to enrich each content with the specifically dedicated add-ons (i.e. images of the actors, pictures taken during the shooting, the content dialogues in various languages, an ads or a trailer for cinema or television, etc.).

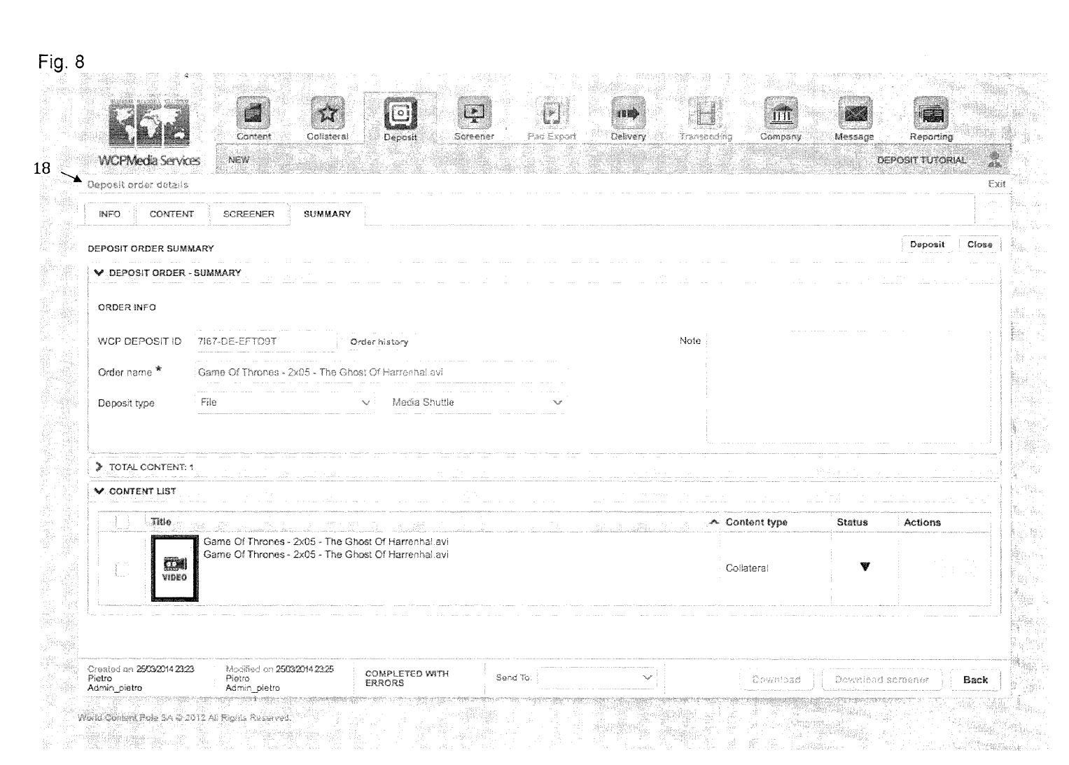

A distinguishing characteristic of the system is that, for video and audio, the system automatically generates and stores a preview, the preview being a lower quality media that can be viewed in streaming directly from the application. This allows the content owner (or the recipient in case of a delivered content) to watch or listen directly the content without the need to download it, the streaming application being part of the system (FIG. 7).

For both content and collaterals the system keeps track of the user that created and last edited the information for any hierarchical level.

As part of the asset management function, the system provides an advanced system to retrieve content and collaterals, based on several information/data fields: the user can select and initialize one or more search field and the system retrieves the content and collaterals that match them.

The means for managing media assets further include means to upload and store the classified content and collaterals in a safe mode.

The system contains means to upload the physical files related to the content and collaterals described and classified.

The system includes means, also indicated with deposit order 18, that allow the user to select multiple content and collaterals that he intends to upload into the platform. The deposit order first allows to specify general information and to select the media to be used for the upload (i.e. sending an hard disk drive that contain the selected items, transferring the file using a Signiant Agent or using a Signiant MediaShuttle).

The user can access a search capability to identify and select the content and collaterals; quick functions are available (i.e. select all the collaterals linked to a content).

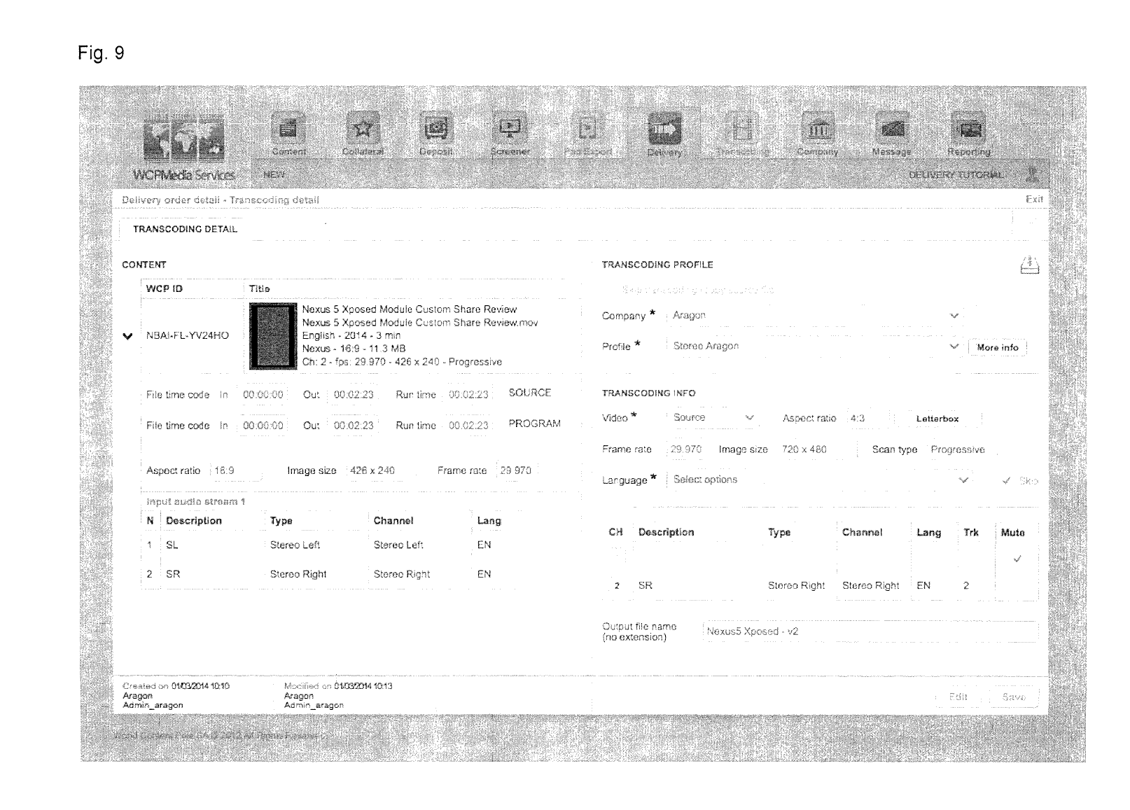

The workflow processor handles the steps that the deposit order 18 has to go through during the process: creation, approval, uploading, completion and closing. Once confirmed, the deposit order 18 automatically perform the physical transfer of the content from the location specified by the user into the application storage, by mean of a program integrated in the system and driven by the workflow processor (FIG. 8).

According to the invention, the means for transcoding 60 the media content support the following.

Means for the company to load one or more transcoding profile technical specification documents, being the information source for the system to prepare related transcoding profiles to be then used during the automatic delivery operations.

Each company user can define within the system a transcoding profile, that means the technical definition of how the company user can ask the system to automatically transcode a content to be used either for internal needs or to be sent to another customer.

The system has a dedicated workflows that drive the user through the steps to be performed: first the user has to define a new transcoding profile entry, characterized by several attributes; then he has to link a document that contains the technical definition of the output transcoding profile (i.e. information like the codec, the output frame rate, the scan type, the aspect ration).

Once the transcoding profile description is ready, the user submits it for preparation. The specification of the document including the technical definition of the transcoding profile are manually entered in a backend of the system by technicians that build and load the specification into a transcoding platform integrated in the system, for instance Rhozet or Vantage.

With the transcoding profile so stored in the system, a “test clip”, sample media content already transcoded in the format required by the user, is generated and send to the user who required the transcoding profile; this user may download the test clip, test it with the production or broadcasting equipment of his company and approve the transcoding profile or reject, if something must be changed.

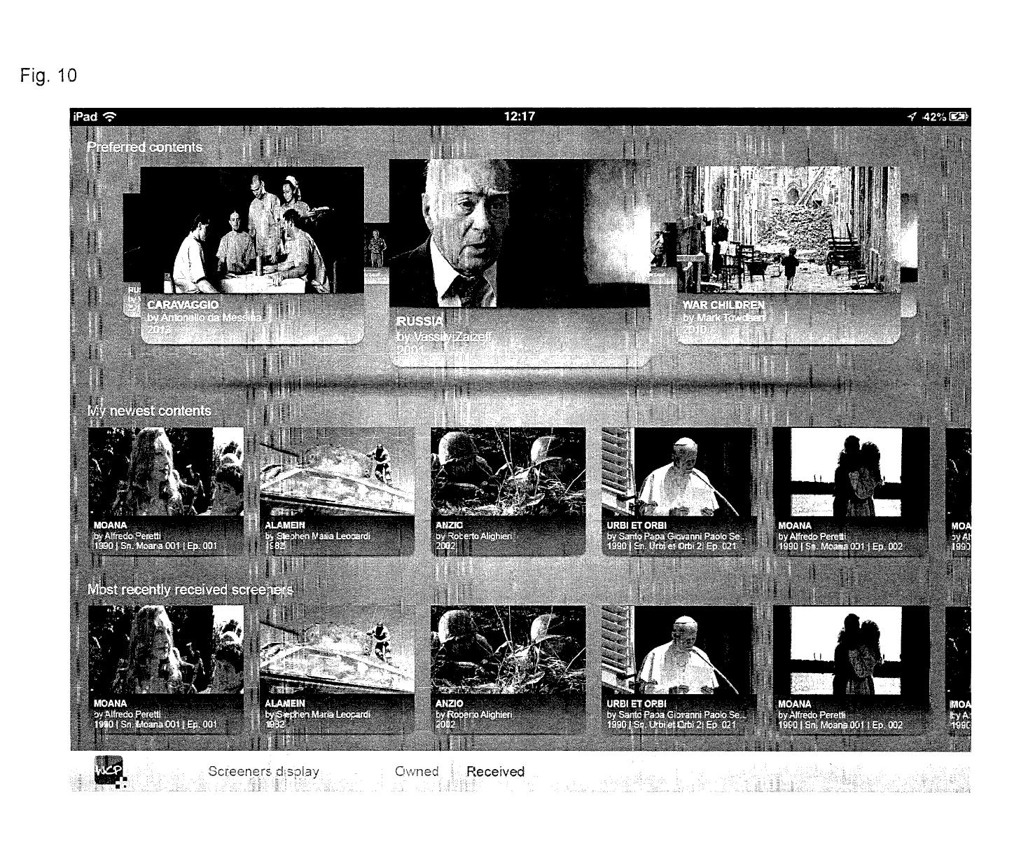

If the transcoding profile is accepted, the system may automatically generate a media content transcoded, according to the specification of the company. More than one transcoding profiles may be defined within the system by the same company, according to its needs and to the needs of its customer (FIG. 9).

The system further includes means to provide a controlled access to content/asset screeners 30 to third party customers, based on internet streaming under a secure protocol.

Once the company has defined and uploaded content into the system, the system can be used to promote and market owned content to third parties, using the screener order.

The screener order allows a company user to make content available to his customers for preview streaming and, if specified, also for download, all the previous without sending any physical support.

The order definition process is guided by the workflow processor where different company users can be involved, according to their power and permission.

Customers can then preview content and, if interested, contact the owning company to ask for a market offering. The owning company may advantageously save on physical delivery costs, avoiding piracy risks and also shortening the process cycle that become virtually immediate.

More particularly, means are provided to control access to content information and screener with tablet based application tightly integrated with the web based system.

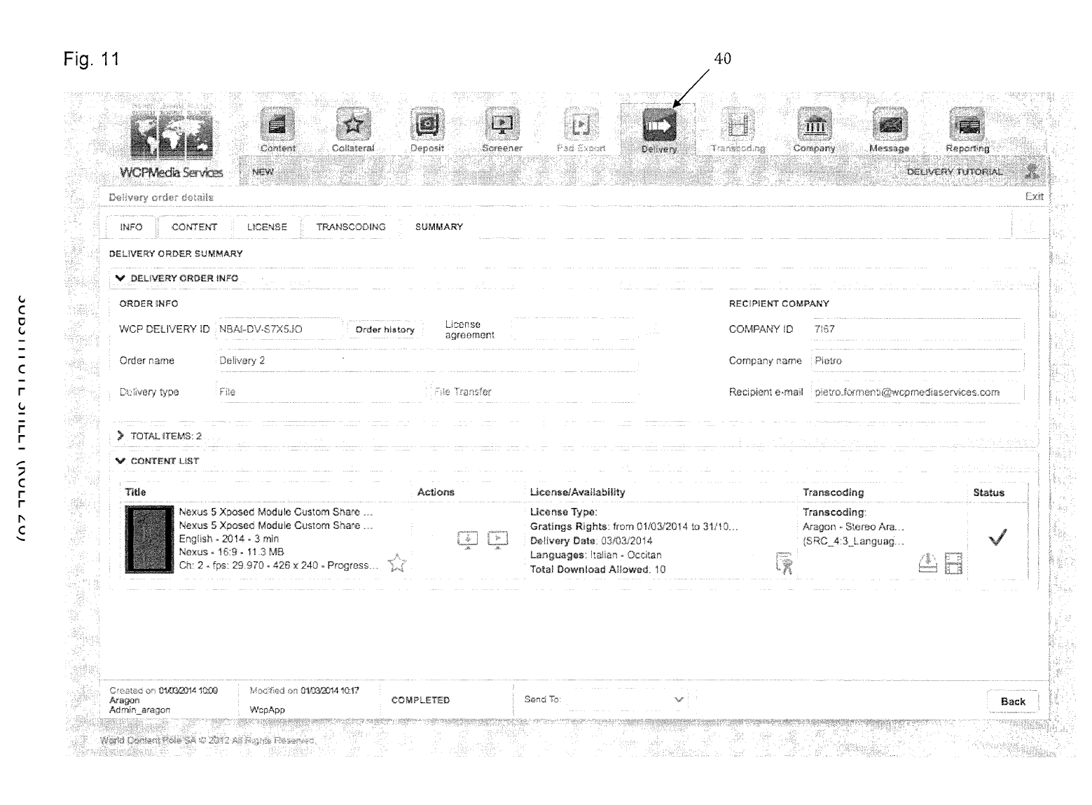

The system is integrated with a dedicated application (ScreenerApp) that allows access to content information and preview on tablets both iOS or Android based (i.e. iPad). This function allows company buyers and sellers to have at their disposal all the needed media content during festivals, fairs or commercial meetings (FIG. 10).

The content to be made available on the tablet can be selected by the user with a dedicated function into the system, where first the content can be selected among the full library; then the user can specify for each content where it should be positioned in the Tablet application (i.e. among the favorites on in the full library).

When one media content is selected, the main information is displayed and the content can be streamed, accessing the system storage where the content and their media are safely stored.

Any user can prepare and populate various “content list”, having them available at the same time; he can then decide when he wants which one should be active and published on his iPad.

Each user, according to his permission, can have his own predefined content lists, without any conflict with other company users in terms of content and/or list.

The system further includes means to automatically generate different media content versions, based on predefined formats or transcoding profiles of the user or users.

A company user can use work-order system function to command the system to generate a new version of a content, based on a specified transcoding profile.

At last, the means for delivering 40 the media content according to the invention, are described here below. More particularly, means are provided to activate the electronic delivery process of media content from one user of company to a user of another company.

A company user, based on the defined and deposited content, can use the system to digitally deliver content and/or collaterals to any third party or customer using the system Delivery order function.

According to the digital delivery, a company may grant access and use to another company of a media content, in the format, for the period and for the rights agreed between the parties. The content itself remains stored within the secure storage the system and so protected from any piracy or risk of damages or loose. When the recipient needs to use the media content, it downloads it from the system storage using the downloading means provided by the system.

The delivery order supports a plurality of function for the user. More particularly, the user may define general order data and the company and user recipient. In case the recipient company is already stored in the system, it is selected together with the corresponding users of the company. On the contrary, if not stored in the system, entering the recipient company name and the email of the recipient user and once the delivery order is approved, the system automatically generates the company and the corresponding user, sends an email to the user, with credentials to become active with the system.

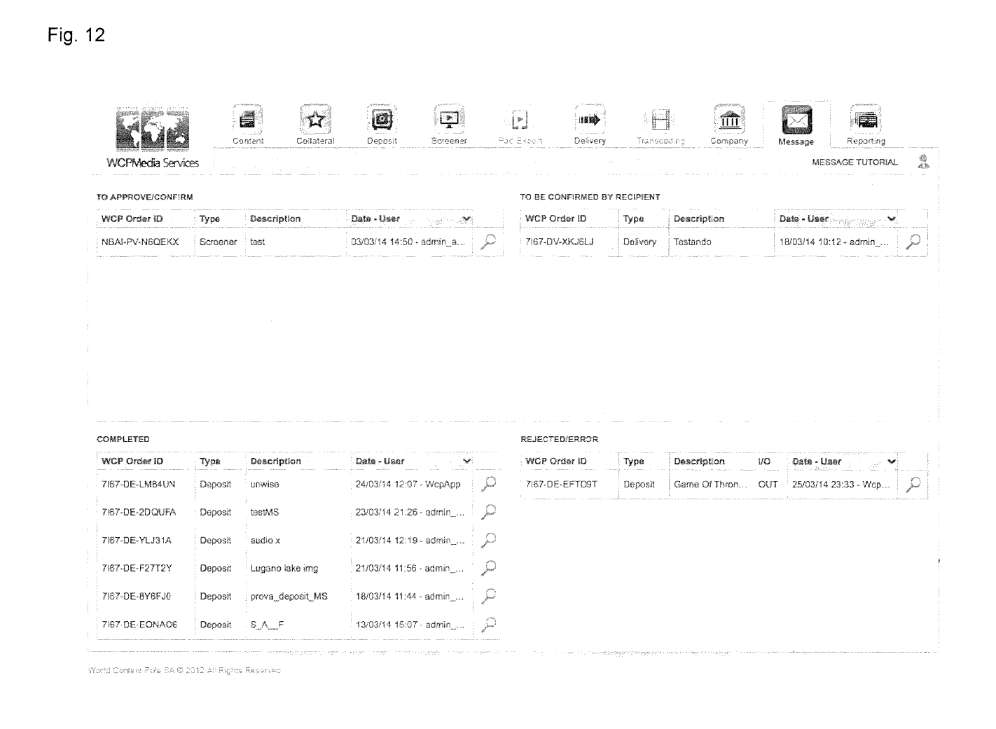

The user recipient may log and accept terms and conditions to become a user of the system. Then, the user has to select the list of content he intends to have delivered. Any type of content/collateral can be delivered by the system (FIG. 11).

Delivery of collaterals is quite simple and does not require much information. Delivery of multimedia content allows specifying rights/license information. According to the license information entered, the system performs different types of controls, including a grant period; more particularly, the system deny download and use the content out of a range of the specified period.

According to the invention, delivery of multimedia content may be performed requesting the transcoding of the content using the transcoding profile agreed by the parties.

In this case, instead of the original content format, the system will perform an automatic transcoding of the content according to the transcoding profile specified in the delivery order.

The resulting new media content is then made available to the recipient according to the agreed license/rights details.

The transcoding profile to be used can be selected only between the sender and the recipient. No other profile existing in the platform under other companies can be accessed and used.

After the user select the transcoding profile, he/she may couple the audio tracks of the source content with the destination audio tracks. He/she can then deliver an “english” language content selecting from the original content the English tracks among the various languages available.

He/she can also deliver a media content adding in the new one audio tracks coming from a dubbing collateral linked to the original content. This function allows the maximum flexibility in terms of structuring of the delivered content audio track structure and content.

In a delivery order it is possible to deliver the same content in different formats and under different rights/license sets.

The previous delivery order process is managed as the previous functions by a dedicated workflow embedded into the system: it controls that the sender and the recipient verifies, approves and confirms the delivery order for the information of their responsibility. In case the recipient rejects the delivery order, the order is sent back to the sender with his reason and the delivery order may be amended and resubmitted.

At every step, the workflow process inform through an email and a message within the system that a new step of the workflow has been accomplished, and the next one is required.

When, at the end of the delivery process, the recipient user has the media content, according to the grant period and the required transcoding format, he can access the media content directly into the system and, if needed, download them.

Means are also provided to track all the internal workflows steps and notify the users of any change in status or action required; notification are based on mailing and/or messages integrated in the system.

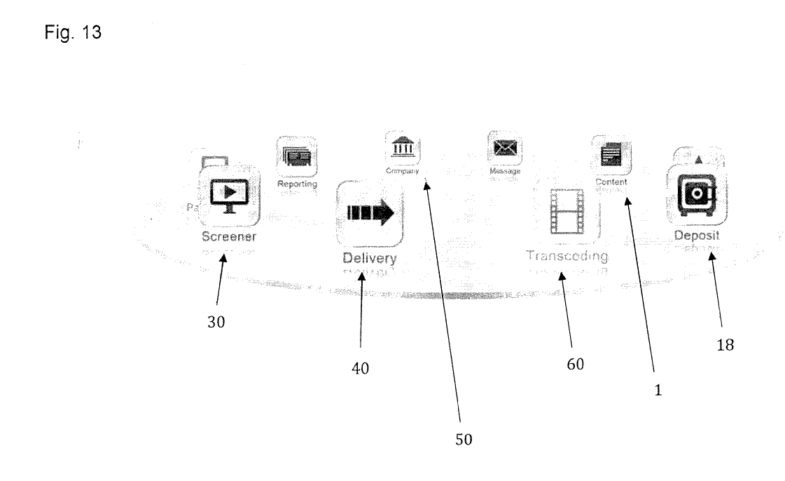

As described above, every time a user create/edit/modify a content or a deposit, screener, work and delivery order, the system keeps track of the action and updates the system with the username of the user which made the action and the corresponding date (FIG. 12).

Advantageously, according to the invention, a plurality of programs for managing asset management, transcoding of media content, delivery and storage of administrative, contractual an accounting data are integrated in the system in a single platform wherein the flow of the media content and all the relevant information between companies, is efficiently managed, reducing the risk of unauthorized copies and improving communication through the companies of the media content industries.

Among these programs, the system preferably includes production software, comprising Harmonic-Rhozet, Telestream-Vantage, streaming software, comprising Wowza, under the coordination of Signiant software to handle file transfers for up/download from/to the user servers, from/to the internal private cloud for storage and from/to the mentioned transcoding software.

All the content and media assets are stored in a private cloud storage system, managed and controlled by the system through a Signiant File manager layer. For security, no user has access physical access to the storage in the cloud; the user can only command actions based on his profile and not perform action directly of a file of the system, such as move, delete, rename.

1-14. (canceled)

15. A system for managing media content for the movie and/or entertainment industry, the system comprising:
means for managing administrative data, including users of the system;
means for managing media assets, including the media content;
means for transcoding the media content;
means for delivering the media content;
wherein the means for managing administrative data, the means for managing media assets, the means for transcoding the media content, and the means for delivering the media content are integrated in a web platform; and
a workflow processor programmed to integrate and implement a management, a transcoding, and a delivery of the media content through actions executed by the users with the means for managing, the means for transcoding, and the means for delivering, and through the administrative data.

16. The system for managing media content according to claim 15, wherein the means for managing administrative data includes:
means to record companies in the system, at least one of the companies being recorded with one or more corresponding transcoding profiles;
means to record users and access data in the system, each of the users being recorded with a corresponding user profile and being associated to one of the companies;
means to control an access of the users to the system on a base of the user profile, the means to control enabling in the system means to at least one of load, edit, play, or download the media content, if the access is given;
means to record data of the transcoding profile, the data including technical parameters to be given in input to a transcoding software to transcode the media content.

17. The system for managing media content according to claim 16, wherein:
a user of the company has a user profile with access rights to terms, conditions, and pricing stored in the system by another user of another company providing a service on a media asset; and
the workflow processor is programmed to drive the flow of the terms, conditions, and pricing between the user and the another user until acceptance of terms, conditions, and pricing.

18. The system for managing media content according to claim 16, wherein a user of the company has a user profile with access rights to require or define the transcoding profile to send or receive multimedia content or collaterals.

19. The system for managing media content according to claim 16, wherein the transcoding profile has a definition including a specification document including at least one of the following information or parameters for transcoding: codec, output frame rate, scan type, or aspect ratio.

20. The system for managing media content according to claim 15, wherein:
the media content and collaterals are structured in a hierarchical form; and
the workflow processor is programmed to upload and store the media content and collaterals through a deposit order.

21. The system for managing media content according to claim 20, wherein the hierarchical form includes, for the media content, levels for storing an original content, a version, a series, an episode, a general information including actors, genre, production year, original language, and technical information including at least one of the following: the file associated to the content, its filename, file size, aspect ratio, frame rate, image size, file time codes, and the description of the audio tracks comprising number, description, type, channel, or language for a single or more audio streams, information on property rights of a licensor, including at least one of rights timeframe, license type, or territory.

22. The system for managing media content according to claim 20, wherein:
the collaterals are stored on a single level; and
each of the collaterals is linkable to any level of the hierarchical structure of the media content.

23. The system for managing media content according to claim 20, wherein the workflow processor is programmed to drive the uploading and storing in the system of the media content and the collaterals through the deposit order, wherein the workflow processor associates the deposit order to a state, including a creation state, an approval state, an uploading state, a completion state and a closing state, and wherein the workflow processors renders available a preview of the content at the closing state.

24. The system for managing media content according to claim 20, further comprising an application to retrieve the media content from the web platform, for display and preview content directly on tablets.

25. The system for managing media content according to claim 16, wherein the means for transcoding the media content include a transcoding software adapted to receive in input the information of the transcoding profile and the media content, and to provide in output a new media content transcoded according to the information of the transcoding profile.

26. The system for managing media content according to claim 15, wherein the means for delivering the media content includes a delivery order including:
information on rights and/or license on the media content, the rights and/or license being agreed through the workflow processor between a company A requesting the media content and a company B owner of the rights;
information on a grant period in which access to the media content in the system is given to the company A; and
a transcoding profile of the company A, to transcode the media content in a format required by the company, the transcoding being driven by the means for transcoding through the workflow processor.

27. The system for managing media content according to claim 15, further comprising means to provide a controlled access to media content screeners based on internet streaming under a secure protocol.

28. A method for managing media content, the method comprising:
managing administrative data;
managing media assets;
transcoding the media content; and
delivering the media content;
the acts of managing administrative data, managing media assets, transcoding, and delivering being integrally executed in a web platform over the Internet and being coordinated with a workflow process.
